(19) United States
(12) Patent Application Publication
(10) Pub. No.: US 2013/0344330 A1
(43) Pub. Date: Dec. 26, 2013

(54) REINFORCING STRANDS AND COMPOSITES HAVING IMPROVED FIRE RESISTANCE

(71) Applicant: OCV Intellectual Capital, LLC, Toledo, OH (US)

(72) Inventors: Jean-Philippe Gasca, St-Jean de la Porte (FR); Carine Chivas, Verneuil-en-Halatte (FR); Anne Bergeret, Ales (FR); Jose-Marie Lopez-Cuesta, Saint Christophe les Ales (FR)

(73) Assignee: OCV Intellectual Capital, LLC, Toledo, OH (US)

(21) Appl. No.: 14/012,649

(22) Filed: Aug. 28, 2013

Related U.S. Application Data
(63) Continuation of application No. 11/994,709, filed on May 5, 2008, now abandoned.

(30) Foreign Application Priority Data
Jul. 6, 2005 (FR) 0552072

(51) Int. Cl. B32B 5/28

(52) U.S. Cl. CPC B32B 5/28
USPC 428/391; 264/128

(57) ABSTRACT

The present invention relates to a composition for reinforcing strands, characterized in that it includes at least one additive capable of acting at the strands/matrix interface so as to improve the fire resistance of the strands/matrix composite, and it also relates to the strands and composites obtained.

The present invention relates to strands (or fibres) capable of reinforcing organic and/or inorganic materials, and also to the reinforced products (or composites) obtained, these reinforcing strands and these composites having improved fire resistance. The present invention also relates to the composition used to coat these strands and to the process for manufacturing these strands.

The present invention relates in particular to glass reinforcing strands that can be obtained by mechanically attenuating, at high speed (up to a few tens of metres per second), streams of molten glass flowing out of orifices in the base of one or more bushings. These strands are attenuated in the form of filaments, said filaments being coated, before they are assembled into strands, with a composition, called a size composition, intended in particular for protecting the strands from abrasion, for allowing the strands to be combined with the matrix (one or more organic materials and/or one or more inorganic materials) to be reinforced, etc.

Although the glass strands possess remarkable properties, which are found in the composite products produced, they have however a negative effect as regards the fire resistance of these composites, possibly facilitating flame spread within said composites. The conventional fire retardants Incorporated into the matrix do not really eliminate this effect since the fire resistance values achieved in this case remain insufficient, in particular the values are below the level achieved in the absence of reinforcing strands.

The aim of the present invention is to solve this problem and it has been found that the addition to the size composition of a component that is not necessarily itself a recognized fire retardant but acts at the strands/matrix interface(s) within the composites produced, thus delaying ignition or accelerating self-extinction, improves the fire resistance of the composite without however impairing its properties (especially its mechanical properties) or the processing of the reinforcing strands,

The first object of the present invention is therefore a composition, in particular a size composition, used to coat reinforcing strands, in particular glass strands, characterized in that it includes at least one additive capable of acting at (or of modifying) the strand/matrix interfaces so as to improve the fire resistance of the reinforcing strands/matrix composite, especially by delaying ignition and/or accelerating self-extinction, without thereby impairing the mechanical properties of the composite or the processing of the strands.

The ignition delay and/or self-extinction acceleration take place as a result of at least one phenomenon occurring essentially at the strands/matrix interface and preferably leading to a reduction in heat transfer at the interface, especially by the formation of a carbon layer, the additive for example being a carbon donor or acting as an oxidizing agent which cuts the chains of the matrix at the interface and promotes crosslinking, or interacting with a flame retardant of the matrix, etc., without being tied by any one theory regarding these various possible modes of action.

The additive or additives capable of modifying the strands/matrix interface so as to improve the fire resistance of the strands/matrix composite (without thereby impairing the mechanical properties or the processing) may be especially chosen from:
nitrates, such as potassium nitrate (KNO₃) or guanidine nitrate;
alcohols and their derivatives, such as pentaerythritol and its derivatives, particularly dipentaerythritol, tripentaerythritol, ethoxylated pentaerythritol, propoxylated pentaerythritol, ethoxylated/propoxylated pentaerythritol, or sorbitol (or D-glucitol); and
phosphorus derivatives or phosphoric acid derivatives, organophosphorus compounds, cyclic ester phosphates or organophosphinates, such as ammonium polyphosphate, guanidine phosphate, 1,2,3-dioxaphosphorinane, or ammonium pyrophosphate,
   these one or more additives preferably being chosen among nitrates such as potassium nitrate (KNO₃) or guanidine nitrate (the preferred nitrate being the potassium nitrate), and/or among alcohols (and their derivatives) of the sorbitol or pentaerythritol derivatives type, preferably (notably when the reinforcing strands are intended to be cut or chopped) among ethoxylated pentaerythritol, propoxylated pentaerythritol, ethoxylated/propoxylated pentaerythritol, and sorbitol, and particularly preferably among ethoxylated pentaerythritol and sorbitol.

The additives chosen according to the invention do not normally form part of products conventionally classified as fire retardants, and would for example have no effect against fire should they be incorporated, in particular alone and at the same rate, into the matrix itself rather than on the strands. As indicated above, their action is essentially exerted at the strands/matrix interface (in particular at the size/strand and/or size/matrix interfaces), it being possible for said compound(s) to interact, where appropriate, at said interface, with the matrix and/or the flame retardant(s) of the matrix and/or with other components of the size.

It should be noted that the composition according to the invention advantageously contains no red phosphorus, no antimony oxide nor halogenated compounds, the latter moreover being harmful to the environment.

Preferably, the additive(s) capable of modifying the strands/matrix interface according to the invention is (are) soluble, dispersible or emulsifiable in water and/or In (the rest of) the composition. Since the composition according to the invention is generally an aqueous composition, the solids content of the composition is in this case preferably between 1 and 20% by weight of the composition (the composition comprising between 80 and 99% water by weight), especially between 2 and 10% by weight. In other embodiments, the composition according to the invention may contain no water or may include other solvents.

The content of additive(s) capable of modifying the strands/matrix interface according to the invention is (are) generally between 1 and 60% and preferably between 2 and 40% by weight of the solids content of the composition.

The composition (preferably size composition) may also contain at least one coupling agent, generally for coupling the reinforcing strands (particularly glass strands) to the matrix to be reinforced. This coupling agent may especially be chosen from silanes, titanates and zirconates, and is preferably chosen from silanes (in particular from aminosilanes, epoxysllanes, etc.). The content of coupling agent(s) is then preferably between 1 and 50% by weight, advantageously between 2 and 20% by weight and particularly preferably between 5 and 15% by weight of the solids content of the composition.

The composition may also contain at least one bonding (film forming) agent, this agent generally acting on the processability of the strand (stiffness, inter-filament cohesion, etc.) and being for example chosen from polyurethanes, epoxy resins, acrylic copolymers, polyvinyl acetates and polyolefin emulsions, the content of bonding (film former) agent(s) being, as the case may be (when it (they) is (are) present), between 10 and 90% and preferably between 20 and 80% by weight of the solids content of the composition. Preferably, the composition includes at least one bonding agent capable of fixing the additive according to the invention to the surface of the strands so that it remains at the strand/matrix interface, this film former being advantageously in the form of a polyurethane and being in particular chosen so as to be little soluble in the matrix or not excessively diffusing to the interfaces. It may for example be a polyurethane intended to be crosslinked after deposition of the composition on the strand(s) (for example during a drying operation), this polyurethane being self-crosslinking (in particular having functional groups capable of crosslinking, such as isocyanate groups, within the actual polymer chain) or being blended with a crosslinking agent (representing for example around 2 to 50% by weight of the polyurethane/crosslinking agent blend), such as a polyisocyanate or a polycarbodiimide, these crosslinking functional groups possibly being blocked by a blocking agent (which may for example be unblocked by heat treatment), such as caprolactam or butanone oxime.

Where appropriate, several different bonding film forming agents (particularly polyurethane) or only one bonding agent that fulfils several functions, can be used. For example, it is possible to use at least one bonding agent, especially promoting good mechanical properties (and/or allowing, where appropriate, the maintaining of the additive, and possibly of the other components, on the strands, as mentioned above), and optionally at least one other bonding agent capable of protecting the reinforcing strands and/or making it easier to process them.

Finally, the composition (in particular size composition) according to the invention may include at least one other standard agent (generally up to 20% by weight of its solid content), this agent being for example chosen from lubricants (for example an ethoxylated fatty alcohol ester), emulsifiers or surfactants (for example, stearyl alcohol containing 20 mol of ethylene oxide), antistatic agents, anti-foaming agents, wetting agents, textile agents, etc.

As mentioned above, the composition generally includes at least one solvent, especially water. Where appropriate, certain active components may have already been dissolved or dispersed in a solvent during their addition to the mixture that has to form the composition, and/or the solvent(s) may be added to the mixture after the active components so as to obtain the viscosity and the proportions that are usually required for the depositionon the filaments.

One preferred size composition according to the invention has for example the following formulation:

| | wt. % of the solids content |
|---|---|
| Ingredients | of the composition |
| Organosilane coupling agent(s) | 1-50 |
| Polyurethane bonding agent(s) | 10-90 |
| KNO₃ | 1-60 |
| Lubricant(s) | 0-20 |

The present invention also relates to reinforcing strands (advantageously glass strands) coated with the above composition, it being possible for said strands to be in various forms, such as continuous strands, chopped strands, braids, tapes, mats, etc.

The content of composition deposited (or loss on ignition) is advantageously 0.1 to 3% by weight, preferably 0.2 to 1.5% by weight, of the strands.

The composition according to the invention may be deposited in one or more steps on filaments (that have to form the strands) and/or on the reinforcing strands. The composites obtained from the strands generally comprise at least one organic material and reinforcing strands, at least some of the reinforcing strands being the strands according to the invention.

An object of the present invention is also a process for manufacturing glass strands coated with the composition according to the invention, in which a multiplicity of molten glass strands, flowing out of a multiplicity of orifices In the base of one or more dies (or bushings), are drawn (or attenuated) (at speeds of several metres per second to several tens of metres per second) in the form of one or more sheets of continuous filaments (generally with a diameter of between 5 and 24 μm) and then the filaments are assembled into one or more strands that are collected on a moving support, said process consisting in depositing, on the surface of the filaments while they are being drawn and before the filaments are assembled into one or more strands, at least some of the size composition according to the invention, the strand(s) being, where appropriate, coated with the complete composition at the latest during collection of the strand(s).

The strands may be collected in various ways. In particular, they may be chopped, either after formation by the device used to draw them, or in a subsequent operation, or else they may be wound on rotating supports (in order to form windings such as rovings, cops, cakes, etc.), or else they may be distributed on moving conveyors (in order to form for example mats or veils). Where appropriate, the strands may be dried (for example by infrared radiation, hot air, high frequency, etc.), since the water may impair the good adhesion between the strands and the materials to be reinforced, and/or they may be heat treated (at temperatures possibly ranging for example up to 200° C.) so as to allow, where appropriate, curing and/or crosslinking of all or part of the size.

It should be noted in the present invention that the term “glass strands” is understood to mean strands based on glass, that is to say not only strands formed only from glass filaments but also strands formed from both glass filaments and organic filaments, especially thermoplastic filaments. In the latter case, during attenuation of the glass filaments, the organic filaments are extruded and simultaneously entrained therewith (or else the organic strands, coming for example from packages, are supplied simultaneously), the paths followed by the glass filaments and the organic filaments (or strands) converging on one another before said filaments are assembled into at least one mechanically entrained composite strand.

The object of the present invention is also a composite comprising at least one organic material and at least strands as defined above.

The organic material is advantageously a thermoplastic, especially chosen from polyamides, thermoplastic polyesters, such as polybutylene terephthalate (PBT) and polyethylene terephthalate (PET), polyolefins, polyacetals, polycarbonates, etc.

The mouldable matrix composition used to obtain the composite by moulding may also contain (apart from the material to be reinforced and the reinforcing strands) at least one flame-retarding agent (for example cyanurate, such as melamine cyanurate and/or an organophosphorus compound, such as melamine pyrophosphate) and/or may in particular contain fillers providing good mechanical strength and/or dimensional stability of the composite (for example mineral fillers of the type comprising mica, talc, etc.).

A mouldable matrix composition according to the invention may advantageously have the following formulation:
20 to 95% by weight of organic material(s);
1 to 60%, especially 5 to 40% and preferably 10 to 30% by weight of at least one flame-retarding agent;
1 to 60% by weight, and preferably 10 to 40% by weight, of sized strands according to the invention; and
0 to 50% by weight of inorganic/mineral fillers.

The following example illustrates the present invention without however limiting its scope:

A size composition having the formulation below was prepared by mixing its various ingredients in water.

| | wt. % of the solids content |
|---|---|
| Ingredient | of the composition |
| Aminosilane sold by GE Silicone under the | 10 |
| name A 1100 | |
| Polyurethane, with a crosslinking agent, sold | 67 |
| by Bayer under the name Baybond PU130 | |
| (introduced in aqueous dispersion form at | |
| 30 wt. % solids content) | |
| KNO₃ | 20 |
| Stearylic alcohol containing 20 mol ethylene | 3 |
| oxide | |

Glass strands were manufactured by drawing molten glass filaments from a bushing, the above size composition being deposited before the filaments were grouped together into strand(s).

The strands obtained were then chopped directly beneath the bushing and a mouldable composition having the following formulation was prepared:

| Ingredient | % by weight |
|---|---|
| Matrix composed of polyamid-6 | 50 |
| (Ultramid B3 sold by BASF) | |
| Melamine pyrophosphate flame-retarding | 25 |
| agent (sold by Buddenheim under the name | |
| Budit 311 MPP) | |
| Chopped sized strands | 25 |

A composite moulded part was then obtained form the above mouldable composition by extrusion followed by injection moulding.

Each of the following tests were then carried out: LOI test (according to the ISO 4589-2/1996F standard); Epiradiateur test (according to the NFP 92-505 standard) and the cone calorimeter test (according to the ASTM E1354 standard). The trials were carried out on specimens produced according to the present example (“Fibre (KNO₃)” results below) and on comparative specimens obtained by replacing the strands according to the present example with strands that had been sized with the same composition but without KNO₃ (“Control fibre” results below). The results are given in the following table.

| | | Control | |
|---|---|---|---|
| Test | | fibre | Fibre (KNO₃) |
| Limit oxygen index | (%) | 25.6 | 28.2 |
| (ISO 4589-2/1996F) | | | |
| Epiradiateur | Ignition time (s) | 30 | 170 |
| (NF P92-505) | Mean burn time (s) | 41 | 18 |
| Cone calorimeter | HRR peak | 306 | 203 |
| (ASTM E1354) | (kW/m²) | | |

The LOI test consisted in determining the oxygen concentration in an oxygen/nitrogen mixture that allowed the combustion of a material for a given time (180 seconds) and over a given length (50 mm). The results of this test show that it is more difficult to maintain combustion in the case of the products according to the invention. Likewise, in the case of the Epiradiateur test, it is clearly apparent that a much longer time is required for the products according to the invention to catch fire and that these products are extinguished much more rapidly. Finally, the cone calorimeter test shows that the energy released by the combustion is much lower in the case of the products according to the invention.

In addition, it should be noted in the following table that these improvements were not to the detriment of the mechanical properties of the composites, the mechanical strength values obtained being of the same order whether the strands of the example or the comparative strands are used (tensile strength values obtained according to the ISO 527-2 standard and Charpy impact strength values according to the ISO 179-1 standard).

| | Control | |
|---|---|---|
| | fibre | Fibre (KNO₃) |
| Tensile strength | 149.4 | 150.1 |
| (MPa) | | |
| Charpy impact | 78.6 | 78.4 |
| strength (kJ/m²) | | |

The reinforcing strands and composite products produced according to the invention may be used in various applications, for example in connectors, in the manufacture of electrical and electronic packages, etc.

What is claimed is:

1. A reinforced composite comprising:
at least one thermoplastic organic polymer matrix; and
a plurality of reinforcing glass strands at least partially coated with a size composition, the size composition comprising, based on the weight of the solids of the size composition:
between 1% and 50% of at least one organosilane coupling agent,
between 10% and 90% of at least one bonding agent, and
between 2% and 40% of at least one additive, wherein the at least one additive is selected from the group consisting of a nitrate, an alcohol, and a phosphorous-containing compound,
wherein the reinforced composite has a greater resistance to fire as compared to an identical reinforced composite lacking said at least one additive.

2. The reinforced composite of claim 1, wherein the greater resistance to fire includes at least one of greater delayed ignition, greater accelerated self-extinction, and combinations thereof.

3. The reinforced composite of claim 1, wherein said nitrate is one of potassium nitrate and guanidine nitrate.

4. The reinforced composite of claim 1, wherein said alcohol is one of pentaerythritol, dipentaerythritol, tripentaerythritol, ethoxylated pentaerythritol, propoxylated pentaerythritol, ethoxylated/propoxylated pentaerythritol, and sorbitol.

5. The reinforced composite of claim 1, wherein said phosphorous-containing compound is one of a phosphorus derivative, a phosphoric acid derivative, a cyclic ester phosphate, and an organophosphinate.

6. The reinforced composite of claim 5, wherein said phosphoric acid derivative is one of ammonium polyphosphate, guanidine phosphate, and ammonium pyrophosphate.

7. The reinforced composite of claim 1, wherein the size composition contains at least 20% of the at least one additive based on the total weight of the solids of the size composition.

8. The reinforced composite of claim 1, wherein the at least one bonding agent is selected from the group consisting of polyurethanes, epoxies, acrylic copolymers, polyvinyl acetate, and polyolefin emulsions.

9. The reinforced composite of claim 8, wherein the at least one bonding agent is a polyurethane.

10. The reinforced composite of claim 8, wherein the at least one bonding agent is an aqueous polyurethane dispersion.

11. The reinforced composite of claim 1, wherein the size composition does not contain any red phosphorous, antimony oxide, or halogenated compounds.

12. The reinforced composite of claim 1, wherein at least a portion of a total additive content of the size composition is affixed to the surfaces of the plurality of reinforcing glass strands.

13. The reinforced composite of claim 1, wherein the reinforced composite comprises, based on the weight percent of the total reinforced composite:
20% to 95% of the at least one thermoplastic organic polymer matrix;
1% to 60% of at least one flame-retarding agent;
1% to 60% of the plurality of reinforcing glass strands; and
0% to 50% of at least one inorganic or mineral filler.

14. The reinforced composite of claim 1, wherein the at least one thermoplastic organic polymer matrix is selected from polyamides, thermoplastic polyesters, polyolefins, polyacetals, and polycarbonates.

15. A method for improving the fire resistance of a reinforced composite comprising a thermoplastic organic polymer matrix, the method comprising:
depositing on the surface of a plurality of glass filaments a size composition comprising:
between 1% and 50% of at least one organosilane coupling agent,
between 10% and 90% of at least one bonding agent, and
between 2% and 40% of at least one additive, wherein the at least one additive is selected from the group consisting of a nitrate, an alcohol, and a phosphorous-containing compound;
assembling the plurality of glass filaments into one or more glass strands;
drying or curing the size composition deposited on the one or more glass strands, wherein when dried or cured, at least a portion of a total additive content of the size composition is affixed to the surface of the one or more glass strands; and
forming a reinforced composite by combining the thermoplastic organic polymer matrix with said one or more glass strands,
whereby the reinforced composite has a greater resistance to fire as compared to an identical reinforced composite lacking said at least one additive.

16. The method of claim 15, wherein the greater resistance to fire includes at least one of greater delayed ignition, greater accelerated self-extinction, and combinations thereof.

17. The method of claim 15, wherein said nitrate is one of potassium nitrate and guanidine nitrate.

18. The method of claim 15, wherein said alcohol is one of pentaerythritol, dipentaerythritol, tripentaerythritol, ethoxylated pentaerythritol, propoxylated pentaerythritol, ethoxylated/propoxylated pentaerythritol, and sorbitol.

19. The method of claim 15, wherein said phosphorous-containing compound is one of a phosphorus derivative, a phosphoric acid derivative, a cyclic ester phosphate, and an organophosphinate.

20. The method of claim 16, wherein the at least one bonding agent is a polyurethane.
